(19) United States
(12) Patent Application Publication
(10) Pub. No.: US 2006/0004565 A1
(43) Pub. Date: Jan. 5, 2006

(54) Audio signal encoding device and storage medium for storing encoding program

(75) Inventor: Nobuhide Eguchi, Yokohama (JP)

Correspondence Address: SWIDLER BERLIN LLP, 3000 K STREET, NW, BOX IP, WASHINGTON, DC, 20007, US

(73) Assignee: Fujitsu Limited

(21) Appl. No.: 11/019,610

(22) Filed: Dec. 23, 2004

(30) Foreign Application Priority Data
Jul. 1, 2004 (JP) 2004-195713

(51) Int. Cl. G10L 19/00

(52) U.S. Cl. 704/200.1

(57) ABSTRACT

An encoding device which encodes audio signals comprises a spectrum power calculation unit for calculating the power of each spectrum obtained by analyzing the frequency of an input audio signal, a tonality parameter calculation unit for calculating a tonality parameter indicating the pure tone level of the input audio signal in each sub-band, using the result of the calculation when dividing the frequency range of the spectrum of the input audio signal into a plurality of sub-bands, and a dynamic masking threshold calculation unit for calculating a dynamic masking threshold value of the masking energy of the input audio signal, using the calculated tonality parameter.

### BACKGROUND OF THE INVENTION

1. Field of the Invention

The present invention relates to the encoding method of an audio signal, more particularly, an audio signal encoding device using an MPEG method or the like, for reducing quantizing noise by determining the pure tone level of an input audio signal and appropriately masking the audio signal, according to the result of the determination in the encoding process of the encoding device and a storage medium for storing such an encoding program.

2. Description of the Related Art

With the recent progress of a digital compression technology, personal computers, portable terminals and the like have become compatible with a variety of data forms, such as text, audio (audio frequency), voice, picture and the like.

The compression-encoding method of audio signals is standardized as MPEG1 audio by MPEG, and three types of modes of layer 1 through layer 3 are specified. As these standards, there are, for example, MP3 for MPEG1, and AAC (advanced audio coding) and the like for MPEG2. As to MP3 and MPEG2-AAC, an encoding algorithm is standardized by ISO (International Organization for Standardization)/IEC (International Electro-technical Commission) 11172-3 and ISO/IEC13818-7, respectively.

In the recommendations on these standardizations, although each decoding process is described in detail, as for each encoding process (encode process), only its summary is shown. The respective summaries of these recommended encoding algorithms are described in the following paragraphs (i) through (iii).

(i) An encoding device converts the frequency of an inputted audio signal. In this case, an audio signal means one obtained by a microphone, an amplifier and the like.

(ii) An encoding device determines the allowable quantization error (masking characteristic) of the frequency-converted frequency component for each frequency band using a hearing characteristic.

(iii) An encoding device encodes both each frequency component converted in paragraph (i) and the gain of each frequency band in such a way that quantizing noise generated when applying inverse quantization after quantization may not exceed the masking characteristic determined in paragraph (ii).

Therefore, as to an encoding process, it is passable if the format (grammar) of the encoded bit string (bit stream) of an audio signal is based on the recommendations. As an audio decoding device, for example, one based on the ISO standards is used. In other words, it is passable if the format of an encoded bit stream can be decoded based on a predetermined decoding algorithm. In that sense, the scope of an encoding algorithm has fairly wide freedom. Therefore, there is no strict specification on the number of bits needed to encode a variety of parameters. Nevertheless, since the audio decoding device corresponds to only a decoding algorithm based on the recommendations, the audio decoding device cannot perform a process different from the recommendations or specification.

The conventional audio signal encoding method is described below with reference to FIGS. 1 through 4. FIGS. 1 and 2 is a block diagram showing the configuration of a general MPEG2-AAC encoder and is a flowchart showing its encoding process, respectively. The adaptive adjustment of a masking level to be targeted by the present invention is a process corresponding to an auditory psychology model of FIGS. 1 and 2, and the details of the prior art concerning the process are shown in FIGS. 3 and 4. The entire process shown in FIGS. 1 and 2 is briefly described below.

In FIGS. 1 and 2, an audio signal inputted to an encoder is given to both an auditory psychology model unit and a modified discrete cosine transform (MDCT) unit. A masking threshold characteristic calculated by the frequency analysis of the auditory psychology model unit is given to a bit rate/distortion control unit, and the transform result of the MDCT unit is given to a TNS, an IS stereo set and an MS stereo set which are optional tools for improving tone quality.

The masking threshold characteristic outputted from the auditory psychology model unit indicates a level perceivable by human being, for each frequency band. If the level of an input audio signal is higher than this level, the signal can be perceived as sound. Reversely, if the level of an input audio signal is lower than the level, the signal cannot be perceived as sound. This masking threshold characteristic is given to the bit rate/distortion control unit, and control is performed so that this noise may not be perceived after decoding, by preventing the level of quantizing noise generated in an encoding process which is performed in the latter half of the flowchart shown in FIG. 2, from exceeding this masking threshold value. Therefore, in the MPEG2-AAC audio encoder, the masking threshold characteristic greatly affects tone quality.

Specifically, in the latter half of the process shown in FIG. 2, both a scale factor and a common scale factor are updated in such a way that a quantization error generated in both a non-linear quantization process which is applied to the MDCT coefficient of each frequency and a subsequent reverse quantization process may be within the allowable range, and that the number of quantization bits is less than the maximum number of quantization bits initially determined in the flowchart shown in FIG. 2. Thus, an encoding bit stream is generated.

FIGS. 3 and 4 are a block diagram showing the configuration of the auditory psychology model unit in the conventional encoding method and a flowchart showing the process, respectively. Although the detailed process of the auditory psychology model unit is specified by ISO/IEC13818-7, there is no need to strictly follow this specification. For example, although according to this specification, a fast Fourier transform (FFT) process must be applied to an input audio signal, in an actual process, the FFT process can also be replaced with the MDCT process shown in FIGS. 1 and 2 since the amount of process of the FFT process is enormous.

In FIG. 3, an input audio signal is converted into an MDCT coefficient, which is a frequency component, by the MDCT process. If the input audio signal is sampled at intervals of 48 kHz, the input audio signal is converted into 1,024 MDCT coefficients. Next, each MDCT coefficient is squared in power calculation, and is converted into power. Then, the mean value of MDCT coefficient power values is calculated for each sub-band for auditory psychology model analysis by power mean value calculation. A sub-band for auditory psychology model analysis is divided as defined by Table B. 2. 1. 9. a Psycho-acoustic parameters for 48 kHz long FFT of ISO/IEC13818-7.

Masking energy which sound with an arbitrary frequency gives to neighboring sound is calculated from the power mean value calculated for each sub-band, using a spreading function. By this process, masking energy enb[sb] is generated according to the spectrum state of the input audio signal. Specifically, not only one spectrum with a specific frequency is calculated, using a spreading function, but enb[sb] is also calculated weighting and taking surrounding spectra into consideration. The masking energy enb[sb] is converted into a masking threshold value nb[sb] in a subsequent dynamic masking threshold value calculation.

In this case, a masking threshold value has nature that its characteristic varies depending on whether sound to be masked is pure tone or noise. Therefore, weighting must be applied to the masking energy calculated by the spreading function in such a way as to reduce the masking level if sound is closer to pure tone and to increase the masking level if sound is close to noise. This weighting coefficient is called a tonality parameter (tb[sb]). The tonality parameter (tb[sb]) has a range of 1.0 to 0.0. If sound is close to pure tone, the tonality parameter approaches 1.0. If sound is noise, the tonality parameter takes 0.0. The dynamic masking threshold value nb[sb] can be expressed using masking energy enb[sb] and a tonality parameter (tb[sb]) as follows.
SNR=tb[sb]*18+(1.0−tb[sb])*6
bc=10ˆ(−SNR/10.0)
nb[sb]=enb[sb]*bc
(sb=0˜68)

The dynamic masking threshold value nb[sb] is compared with a static masking threshold value by static masking threshold comparison, and the larger value is selected. If the audio signal is sampled at intervals of 48 kHz, the static masking threshold value is defined in the qsthr field of Table B. 2. 1. 9. a Psycho-acoustic parameters for 48 kHz long FFT of ISO/IEC13818-7, and the dynamic masking threshold value is compared with this value for each sub-band. qsthr[sb] is expressed in dB (logarithmic expression). Therefore, in order to compare qsthr[sb] with nb[sb], the value of qsthr[sb] must be converted linearly.

The masking threshold value processed by the static masking threshold comparison is re-divided into sub-bands suitable for a quantization process by sub-band conversion. This is because the sub-band division applied at the time of auditory psychology model analysis differs from the sub-band division applied at the time of a quantization process. The definition applied at the time of a quantization process is specified in Table 8.4 scale-factor band for LONG_WINDOW, LONG_START_WINDOW, LONG_STOP_WINDOW at 44.1 kHz and 48 kHz of ISO/IEC13818-7 if an input audio signal is sampled at intervals of 48 kHz.

In ISO/IEC13818-7, in order to calculate a tonality parameter to be used in dynamic masking threshold value calculation, FFT is applied to an input audio signal, and both amplitude information and phase information for each frequency obtained thereby is used. For a compact encoder, an FFT process is a great load. Therefore, as described above, conventionally, the amount of process was reduced by applying an MDCT coefficient needed in an encoding process, at the time of auditory psychology model analysis too.

However, in an MDCT process used instead of such an FFT process, although the cosine component, that is, amplitude information, of each frequency component was calculated, phase information was not calculated. Therefore, a tonality parameter could not be calculated. Therefore, in the calculation process of the dynamic masking threshold value, the process was performed on a condition that a tonality parameter is timewise a specific fixed value. Therefore, a masking level could not adaptively adjusted according to whether the frequency component of the input audio signal is pure tone or noise. Thus, quantizing noise generated in the encoding process of pure tone increases, and as a result, tone quality degrades at the time of decoding, which was a problem.

As above-mentioned encoding method of audio data, the following prior art is disclosed in Japanese Patent Laid-open Application No. 2002-351500.

In this reference, a technology for determining the high/low level of pure tone, based on both the maximum value and mean value of spectrum power across the entire frequency range of an input audio signal and switching a masking characteristic is disclosed.

However, in this technology, the high/low level of pure tone is determined across the entire frequency range, and either a masking characteristic which is flat across the entire frequency range or a reference masking characteristic stored in a ROM is applied to the result of the determination. Therefore, neither a frequency characteristic, such as in which frequency band the power spectrum of the input audio signal has a peak nor a masking threshold characteristic corresponding to its time change could be flexibly adjusted, which was a problem.

### SUMMARY OF THE INVENTION

It is an object of the present invention to improve tone quality in encoding an audio signal.

One aspect of the present invention is a device for encoding audio signals. This device calculates the power of each spectrum obtained by analyzing the frequency of the input audio signal. Then, the device calculates a tonality parameter indicating the pure tone level of the input audio signal in each sub-band when dividing the frequency range of the spectrum of the input audio signal into a plurality of sub-bands, using the result of the calculation. Furthermore, the device calculates a dynamic masking threshold value for the masking energy of the input audio signal, using the calculated tonality parameter.

According to this configuration, by determining the high/low level of pure tone in each frequency range of the power spectrum of an input audio signal and adaptively adjusting a dynamic masking threshold characteristic, the size of quantizing noise can be reduced, and accordingly, tone quality in encoding and decoding audio signals can be improved.

### BRIEF DESCRIPTION OF THE DRAWINGS

FIG. 1 is a block diagram showing the configuration of a conventional AAC encoder;

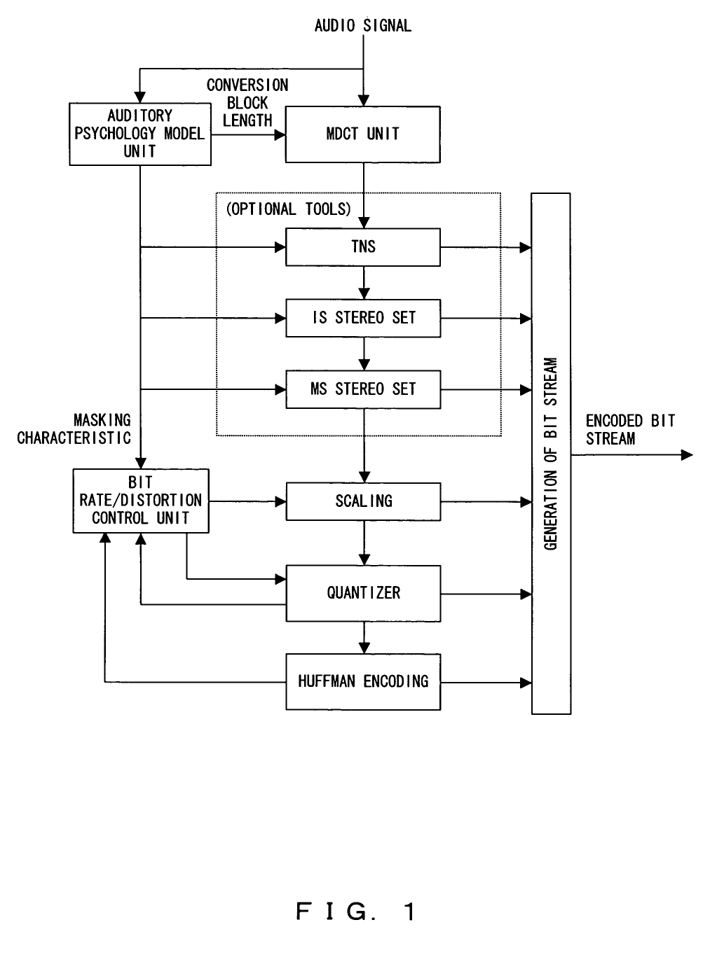

FIG. 2 is a flowchart showing the process of the conventional AAC encoder;

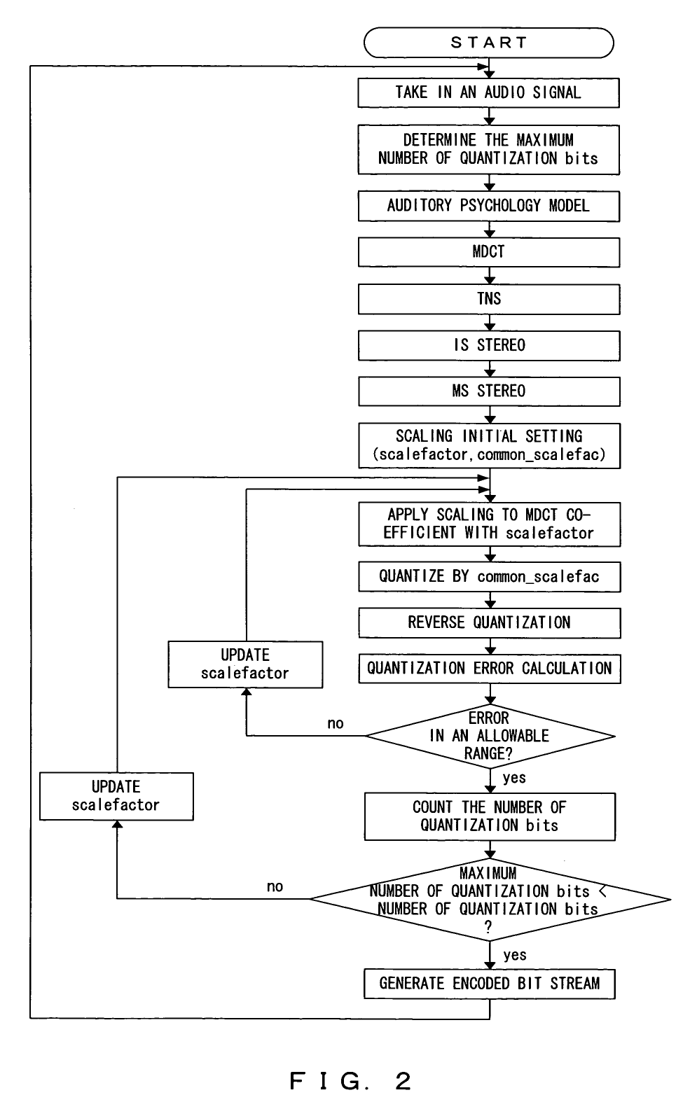

FIG. 3 is a block diagram showing the configuration of a conventional auditory psychology model unit;

FIG. 4 is a flowchart showing the process of the conventional auditory psychology model unit;

FIG. 5 is a block diagram showing the basic configuration of the audio signal encoding device of the present invention;

FIG. 6 shows an example of a sub-band with a high level of pure tone;

FIG. 7 shows an example of a sub-band with a low level of pure tone;

FIG. 8 shows the configuration of an auditory psychology model unit in the preferred embodiment;

FIG. 9 is a flowchart showing an auditory psychology model process in the preferred embodiment;

FIG. 10 is a specific example of sub-band setting for tonality determination;

FIG. 11 is a detailed flowchart showing a maximum value detection process in a sub-band;

FIG. 12 explains the smallest spectrum number inside each sub-band for auditory psychology model analysis;

FIG. 13 is a detailed flowchart showing a spectrum area calculation process;

FIG. 14 is a detailed flowchart showing a sub-band maximum area calculation process;

FIG. 15 is a detailed flowchart showing an area ratio calculation/pure tone level determination process;

FIG. 16 shows a specific example of tonality parameter setting;

FIG. 17 is a detailed flowchart showing a dynamic masking threshold value calculation process; and

FIG. 18 explains how to load a program onto a computer in the present invention.

### DESCRIPTION OF THE PREFERRED EMBODIMENTS

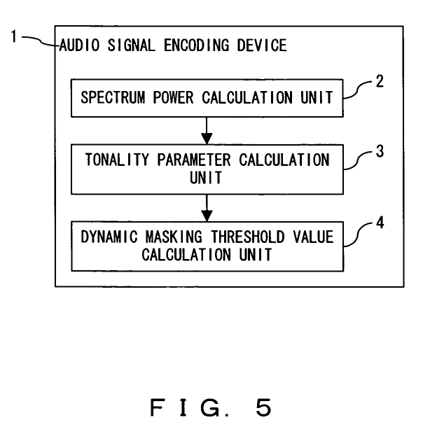

FIG. 5 is a block diagram showing the basic configuration of the audio signal encoding device of the present invention. In FIG. 5, an encoding device 1 comprises a spectrum power calculation unit 2, a tonality parameter calculation unit 3 and a dynamic masking threshold value calculation unit 4.

The spectrum power calculation unit 2 calculates the power of each spectrum obtained by analyzing the frequency of an input audio signal. The tonality parameter calculation unit 3 calculates a tonality parameter indicating the pure tone level of input audio data in each sub-band obtained when dividing the frequency range of the spectrum of the input audio data into a plurality of sub-bands, using the calculation result of the spectrum power. The dynamic masking threshold value calculation unit 4 calculates a dynamic masking threshold value for the masking energy of the input audio signal, using the calculated tonality parameter.

In this case, the tonality parameter calculation unit 3 calculates the sum S_{S} of spectrum power in each of the plurality of sub-bands and the product S_{M} of the maximum value of the spectrum power that exists in each sub-band and the width of the sub-band, and calculates a tonality parameter based on the value of S_{S}/S_{M}.

In the preferred embodiment, if the value of S_{S}/S_{M} is small, the tonality parameter calculation unit 3 can increase the tonality parameter. If the value of S_{S}/S_{M} is large, the tonality parameter calculation unit 3 can decrease the tonality parameter. The tonality parameter calculation unit 3 can also divide the range of this value of S_{S}/S_{M} into a plurality of sub-ranges, and can determine a specific tonality parameter for each of the plurality of divided sub-ranges. Furthermore, the tonality parameter calculation unit 3 can also divide the spectrum frequency range of the input audio data, that is, the plurality of sub-bands, into three sub-bands of low, middle and high bands.

In the preferred embodiment, if the tonality parameter is large, the dynamic masking threshold calculation unit 4 can also decrease the dynamic masking threshold. If the tonality parameter is small, the dynamic masking threshold calculation unit 4 can also increase the dynamic masking threshold.

Next, the audio signal encoding program of the present invention is used to enable a computer to perform a step of calculating the power of each spectrum obtained by analyzing the frequency of an input audio signal, a step of calculating a tonality parameter indicating the pure tone level of input audio data in each sub-band, using the result of the calculation, when dividing the spectrum frequency range of the input audio data into a plurality of sub-bands, and a step of calculating a dynamic masking threshold value of the masking energy of the input audio signal, using the calculated tonality parameter.

In the preferred embodiment of the present invention, both an audio signal encoding method corresponding to a computer-readable portable storage medium on which is recorded this program and this program is used.

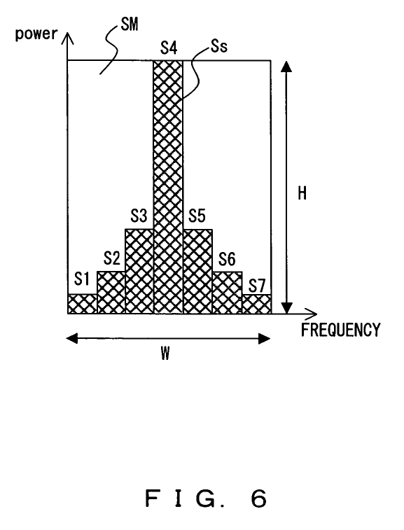

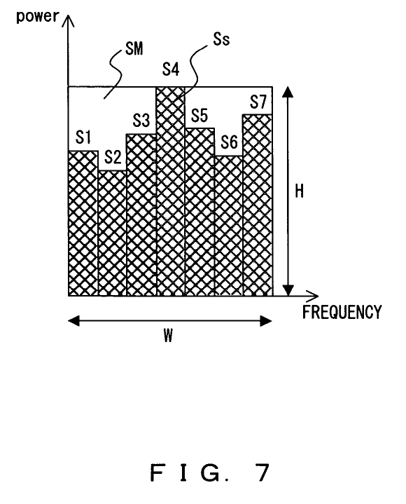

Next, the pure tone level determination method of an input audio signal of the present invention is described with reference to FIGS. 6 and 7. FIG. 6 shows an example of a sub-band with a high pure tone level. If the maximum spectrum power value of the spectrum values in the frequency width W of a sub-band is expressed as H, the product of W and H is expressed as S_{M}, and the total area of spectrum sizes is expressed as S_{S}, in FIG. 6, the ratio of S_{S} to S_{M} decreases, and the pure tone level is determined to be high.

However, in FIG. 7, the ratio of S_{S} to S_{M} increases, and the pure tone level is determined to be low, that is, the noise level is determined to be high.

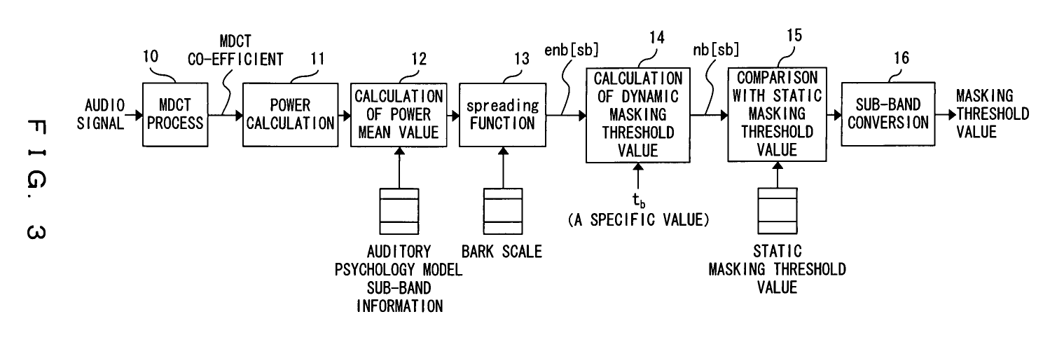

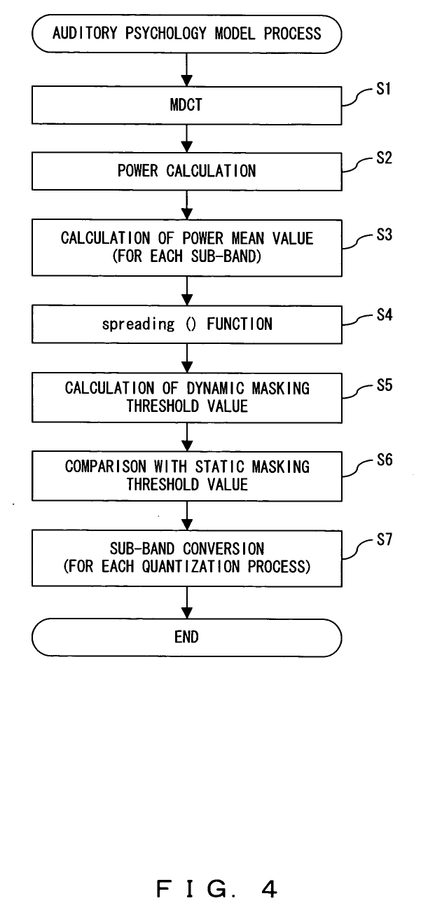

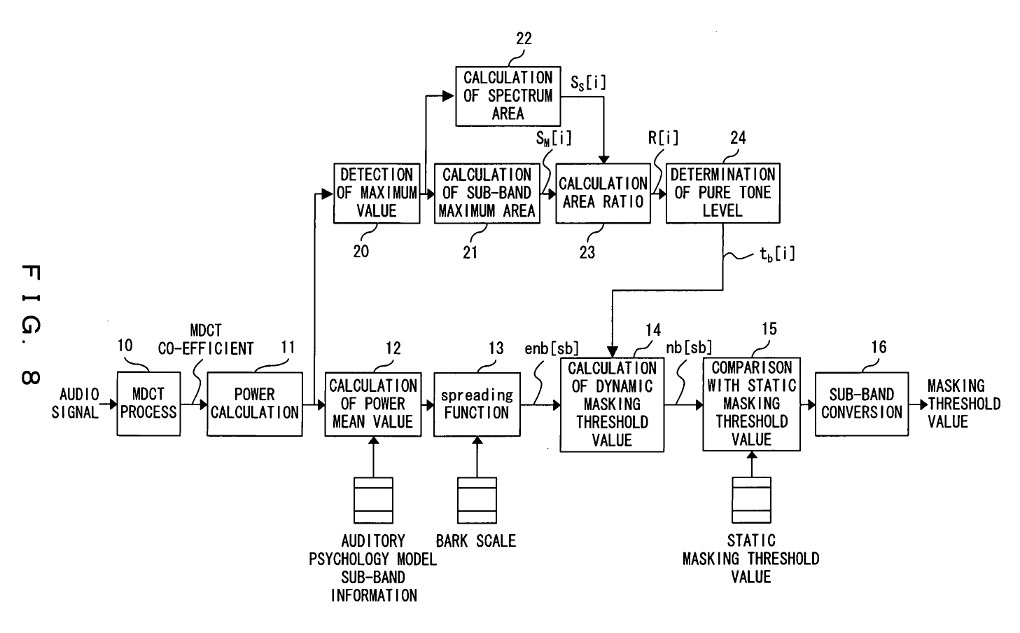

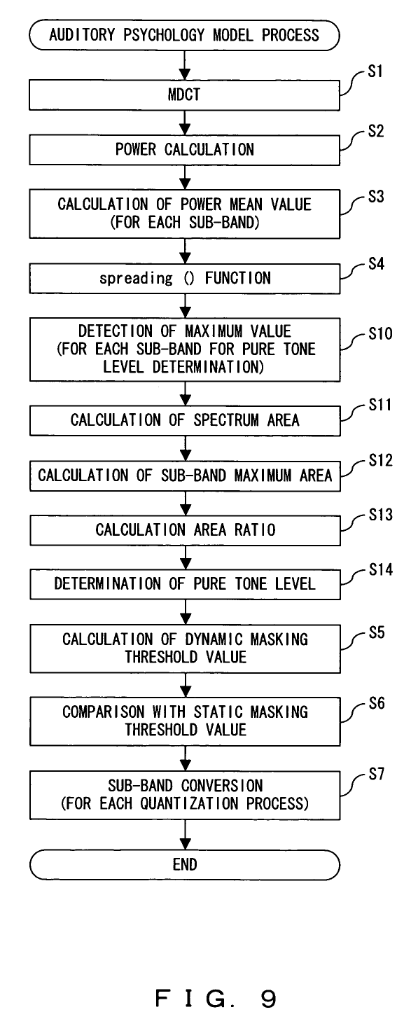

FIG. 8 shows the configuration of an auditory psychology model unit in the present invention. FIG. 9 is a flowchart showing the process of the auditory psychology model unit. FIGS. 8 and 9 are described below in contrast to FIGS. 3 and 4.

In FIG. 8, a process ranging from an MDCT process 10 up to a sub-band conversion 16 differs from the prior art in the calculation method of the dynamic masking threshold value calculation 14. In other words, the process is the same as the prior art except for that a tonality parameter corresponding to each sub-band is used based on sub-band division for tonality determination.

The process differs from the prior art shown in FIGS. 3 and 4 in a block ranging from maximum value detection 20 up to pure tone level determination 24 in FIG. 8, and in a process ranging from maximum value detection in step S10 up to pure tone level determination in step S14 in FIG. 9.

Firstly, in order to determine a pure tone level, the maximum value detection 20 of spectrum power is applied to each of a plurality of sub-bands, three sub-bands in this preferred embodiment, using each spectrum power value calculated by power calculation 11. How to divide a sub-band is described later.

Then, the above-mentioned S_{M}[i] is calculated by sub-band maximum area calculation 21, and the above-mentioned total area S_{S}[i] is calculated by spectrum area calculation 22. In this case, i is an index for a sub-band, that is, the number of a sub-band. Then, a ratio of S_{S}[i] to S_{M}[i] is calculated by area ratio calculation 23, and the value of a tonality parameter tb[i] indicating a pure tone level corresponding to the ratio R[i] is calculated by pure tone level determination 24. This calculation is described in detail later.

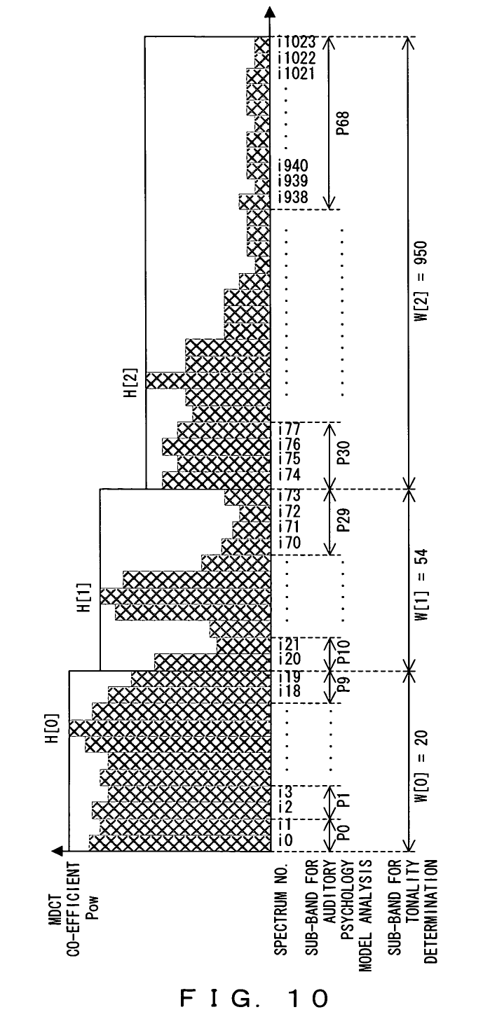

In dynamic masking threshold value calculation 14 shown in FIG. 8, a dynamic masking threshold value nb[sb] (sb=0˜68) corresponding to masking energy enb[sb] (sb=0˜68) calculated in the same way as in the prior art is calculated using tonality parameter tb[i] (i=0˜2) as follows. The use of a different equation by an sb value corresponds to the division of a sub-band described in FIG. 10.
if (sb<10) then tb=tb[0]
else if (sb<30) then tb=tb[1]
else (sb≧30) then tb=tb[2]
SNR=tb*18+(1.0−tb)*6
bc=10ˆ(−SNR/10.0)
nb[sb]=enb[sb]*bc
(sb=0˜68)

Although in FIG. 9, the maximum value detection in step S10 is performed after the process in step S4, it is found that the processes in step S10 to S14 can be performed in parallel to the processes in steps S3 and S4 after the process in step S2 when comparing FIG. 9 with FIG. 8.

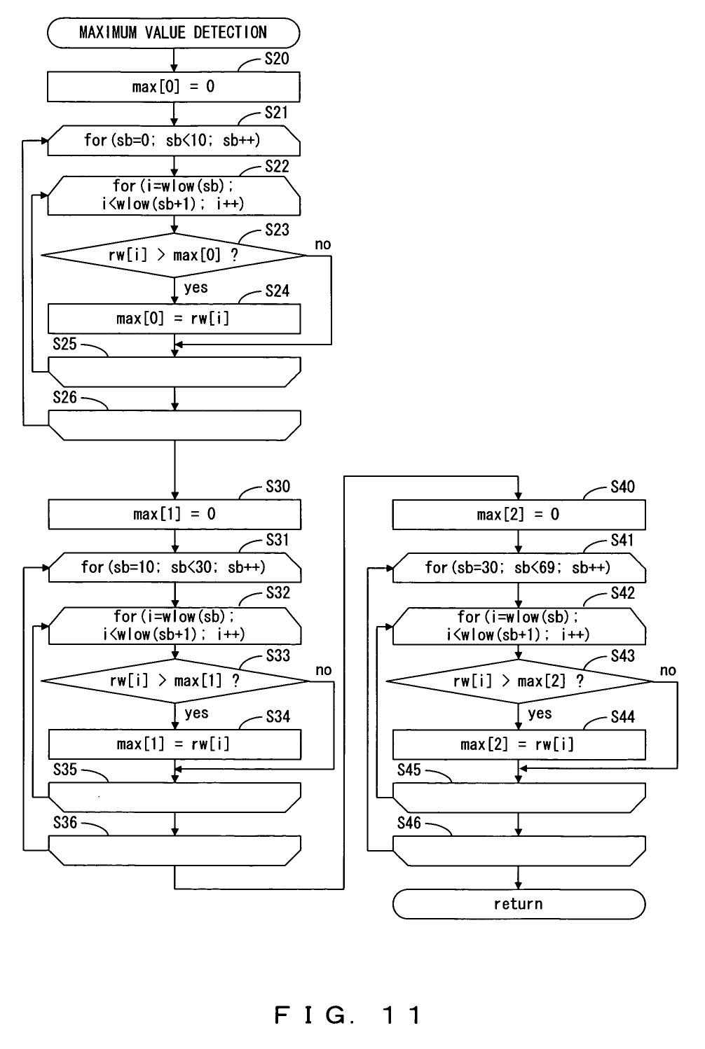

Next, the details of the auditory psychology model process in this preferred embodiment are described using a specific example of sub-band setting for pure tone determination shown in FIG. 10 with reference to FIGS. 11 through 17. In FIG. 10, it is assumed that 1,024 MDCT coefficients are obtained when sampling an input audio signal at intervals of 48 kHz. The total spectrum power of these 1,024 MDCT coefficients is divided into 69 sub-bands (P0-P68) for auditory psychology model analysis. This number of 1,024 corresponds to the number of points in MDCT.

For the details of this sub-band, see Table B. 2. 1. 9. a Psycho-acoustic parameters for 48 kHz ling FFT of ISO/IEC13818-7.

In order to use sub-bands for auditory psychology model analysis as sub-bands for tonality determination, the entire sub-band for auditory psychology model analysis is divided into three sub-bands, P0˜P9, P10˜P29 and P30˜P68.

In this case, each of the respective sizes of bandwidth, W[0]˜W[2] of the three sub-bands is the number of MDCT coefficients that exist in each sub-band.
Namely, W[0]=20(i0˜i19)
W[1]=54(i20˜i73)
W[2]=950(i74˜i1,023)

In this case, if 1,024 MDCT coefficients are mdct_line[i] (i=0˜1,023), respective spectrum total areas S_{S}[0]˜S_{S}[2] in the three sub-bands for tonality determination can be expressed as follows.

$${S}_{S} [ 0 ] = {\sum }_{i = 0}^{19} ( mdct\_line [ i ] * mdct\_line [ i ] )$$

$${S}_{S} [ 1 ] = {\sum }_{i = 20}^{73} ( mdct\_line [ i ] * mdct\_line [ i ] )$$

$${S}_{S} [ 2 ] = {\sum }_{i = 74}^{1023} ( mdct\_line [ i ] * mdct\_line [ i ] )$$

Respective MDCT coefficient power maximum values H[0]H˜[2] in each sub-band for tonality determination can be expressed as follows.
H[0]=max(mdct˜line[i]*mdct_{—}line[i]) (i=0˜19)
H[1]=max (mdct_{—}line[i]*mdct_{—}line[i]) (i=20˜73)
H[2]=max (mdct_{—}line[i]+mdct_{—}line[i]) (i=74˜1,023)

Respective maximum areas S_{M}[0]S_{M}[2] in each sub-band for tonality determination can be expressed as follows.
S_{M}[i]=W[i]*H[i](i=0˜2)

Then, an area ratio R[i] in each sub-band for tonality determination can be expressed as follows.
R[i]=S_{S}[i]/S_{M}[i](i=0˜2)

FIG. 11 is a detailed flowchart showing the maximum value detection process. When in FIG. 11, the process is started, firstly, in step S20, the value of max [0] indicating the maximum spectrum power value in the sub-band with number 0 is initialized to 0. Then, steps S21 through S26, the processes of sub-bands whose number is less than 10, of 69 sub-bands for auditory psychology model analysis are performed starting from sb=0.

In step S22, processes up to step S25 for starting from i which is equal to wlow(sb) up to i which is less than wlow (sb+1) while incrementing i. This wlow(sb) indicates the smallest spectrum number, of a plurality of spectrum numbers included in each of 69 sub-bands, 0 through 68.

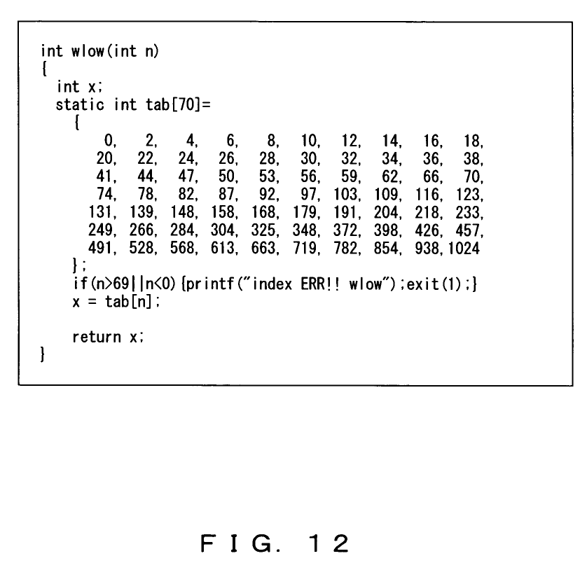

FIG. 12 shows the values of this wlow. When comparing FIG. 12 with FIG. 10, it is found that the wlow value for a sub-band sb=0 is 0, the wlow value for a sub-band sb=1 is 2, the wlow value for a sub-band sb=10, that is, P10 is the eleventh value, that is, 20.

In step S23, as to each segment of spectrum power in a sub-band in which the smallest spectrum number is determined by a wlow (sb) value, it is determined whether its size rw[i] exceeds the value of max[0]. If rw[i] exceeds the value of max[0], in step S24, the value of max[0] is replaced with the value of rw[i] of this spectrum power, and then the value of i is incremented. If rw[i] does not exceed the value of max[0], immediately the value of i is incremented. Then, the processes in steps S22 and after are performed. Thus, in steps S20 through S26, the detection process of the maximum value H[0]=max[0] in a sub-band (i=0) on the low side, of the three sub-bands for tonality determination is completed.

Steps S30 through S36 are for the maximum value detection process of the middle sub-band for tonality determination shown in FIG. 10, and steps S40 through S46 indicate the maximum value detection process of the high sub-band. The contents of each of the middle and high sub-bands are the same as the processes in steps S20 through S26 corresponding to the low sub-band.

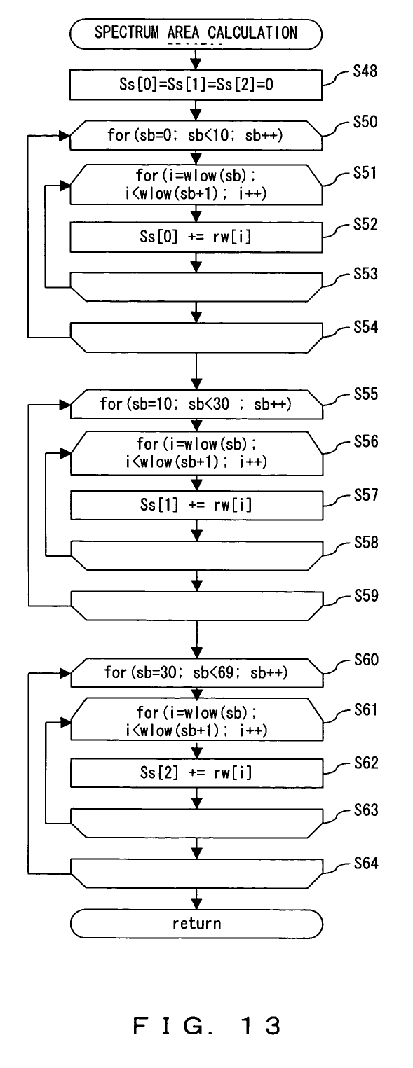

FIG. 13 is a detailed flowchart showing a spectrum area calculation process of each sub-band. When in FIG. 13, the process is started, firstly, in step S48, the respective values of spectrum area S_{S} corresponding to the three sub-bands are all initialized to 0. Then, in steps S50 through S54, steps S55 through S59 and steps S60 through S64, spectrum area calculation processes of the low, middle and high sub-bands, respectively, for tonality determination are performed.

In steps S50 through S54, the process of sub-bands whose sub-band number sb for auditory psychology model analysis is 0 up to value is 10 or less, is started starting one whose sb value is 0, while incrementing the sub-band number. In this process, in steps S51 through S53, each spectrum power rw[i] in such a sub-band is added to S_{S}[0] one after another for i which is less than wlow(sb+1) while incrementing i corresponding to the above-mentioned wlow value of the sub-band. Each of processes in steps S55 through S59 and those in steps S60 through S64 is the same as those in steps S50 through S54.

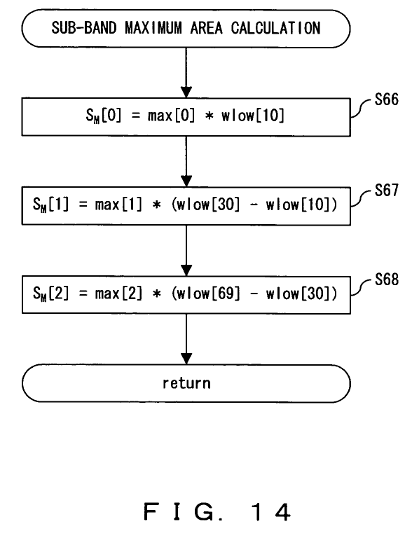

FIG. 14 is a detailed flowchart showing a sub-band maximum area calculation process. In step S66, the value of the sub-band maximum area of the low sub-band, of the three sub-bands for tonality determination shown in FIG. 10 is calculated. Specifically, by multiplying the maximum spectrum power value max[0] in this sub-band by wlow[10], that is, the smallest spectrum number 20 in a sub-band P10 for auditory psychology model analysis shown in FIG. 10, the value of the maximum area S_{M}[0] is calculated.

In steps S67 and S68, the maximum area of the middle sub-band and that of the high sub-band, respectively, are calculated. For example, in step S67, the maximum spectrum power value max[1] in the middle sub-band is multiplied by a difference between wlow[30] and wlow[10], and the value of SM[1] is calculated. In this case, the value of wlow[30] is 74 as shown in FIG. 10. By subtracting the value of the above-mentioned wlow[10] 10 from 74, the number of spectra included in the middle sub-band is calculated.

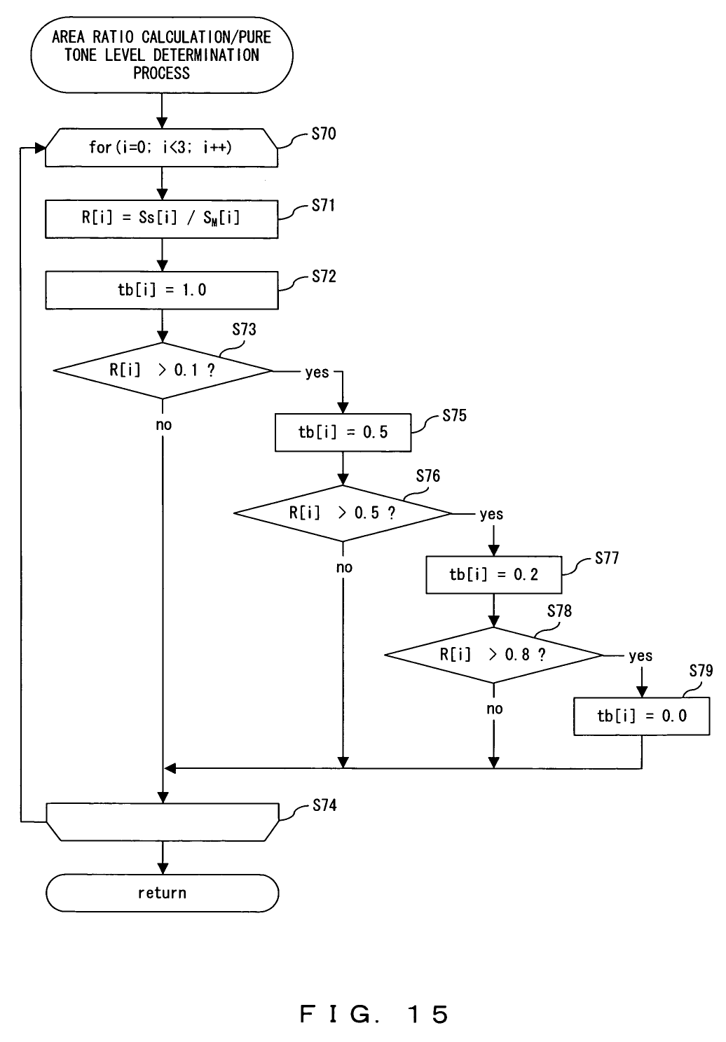

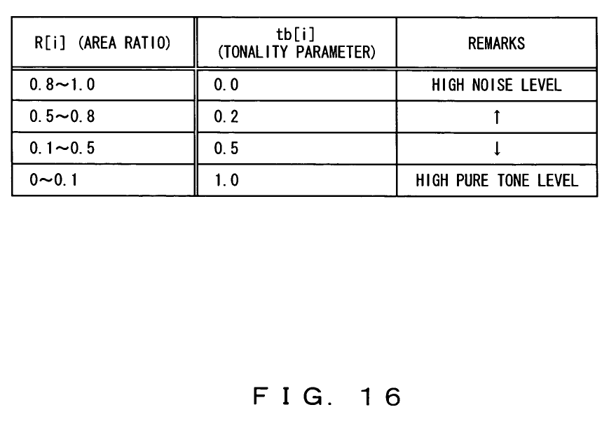

FIG. 15 is a detailed flowchart showing an area ratio calculation/pure tone level determination process. The process shown in FIG. 15 is described below using a specific example of a tonality parameter shown in FIG. 16. When in FIG. 15, the process is started, firstly, the processes in steps S70 through S74 are repeatedly applied to the value of i which is less than 3 while incrementing the value of i indicating the sub-band number for tonality determination, staring from 0. In this process, firstly, in step S71, a ratio R[i] of a spectrum area S_{S}[i] to a sub-band maximum area S_{M}[i] is calculated. In step S72, the value of a tonality parameter tb[i] is set to 1.0. In step S73, it is determined whether R[i] exceeds 0.1.

In a specific example of the tonality parameter shown in FIG. 16, a tonality parameter value is set to 1.0 in the range of an R[i] value of 0 to 0.1 since pure tone level is regarded to be high. Since in step S72 of FIG. 15, the tonality parameter value is set to 1.0, the tonality parameter value must be set to less than 1.0 if the value of R[i] exceeds 0.1. Therefore, if the value of area ratio R[i] does not exceed 0.1, the value of i is incremented and the processes in steps S70 and after are performed. However, if the value of R[i] exceeds 0.1, the process proceeds to step S75.

In step S75, the tonality parameter value is set to 0.5, and in step S76, it is determined whether the area ratio exceeds 0.5. If the area ratio exceeds 0.5, the tonality parameter value must be set to less than 0.5. If the area ratio does not exceed 0.5, the value of i is incremented and the process in steps S70 and after are performed. But then, if the area ratio exceeds 0.5, the process proceeds to step S77.

In step S77, the tonality parameter value is set to 0.2, and in step S78, it is determined whether the area ratio exceeds 0.8. If the area ratio does not exceed 0.8, i is incremented and the processes in steps S70 and after are performed. If the area ratio exceeds 0.8, in step S79, i is incremented and the processes in steps S70 and after are performed after the tonality parameter value is set to 0.0.

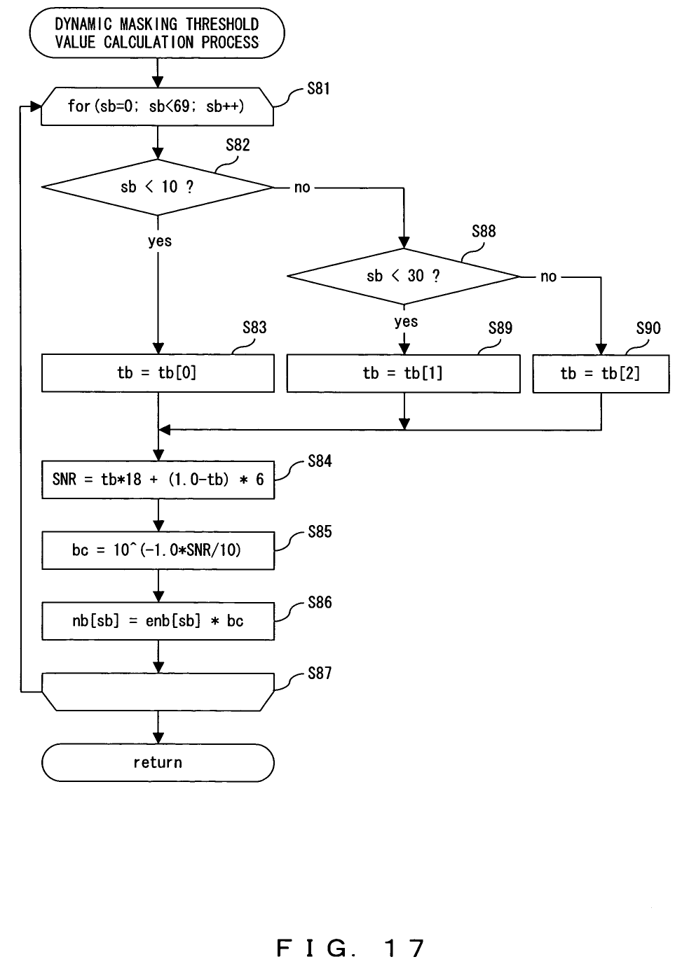

FIG. 17 is a detailed flowchart showing a dynamic masking threshold value calculation process. In FIG. 17, processes corresponding to the above-mentioned equations are performed. In steps S81 through S87, the processes of sub-bands for auditory psychology model analysis whose number sb is 0 up to less than 69 are performed starting from sb=0 while incrementing the value.

In this process, firstly, in step S82, it is determined whether the value of sb is less than 10. If the value sb is less than 10, in step S83, the value of a tonality coefficient tb[0] for the low sub-band is designated as the value of tb in order to perform the process of the low sub-band for tonality determination show in FIG. 10. Then, in steps S84 through S86, a dynamic masking threshold value nb[sb] is calculated.

If in step S82, it is determined that the value of sb is not 10 or more, in step S88, it is determined whether the value is less than 30. If the value is less than 30, the middle sub-band shown in FIG. 10 should be calculated, in step S89, the value of a tonality parameter tb[1] for the middle sub-band is designated as the value of tb, and the processes in steps S84 and after are performed. If the value is 30 or more, the processes in steps S84 and after are performed after in step S90, the value of a tonality parameter tb[2] for the high sub-band is designated as the value of tb.

In the calculation equation of the above-mentioned masking threshold value nb[sb], when tb[i] is close to 1.0, the value of SNR and the value of a coefficient bc become larger and smaller, respectively, than when tb[i] is close to 0.0 (in a higher noise level). In the case of a signal with pure tone, width for reducing the size of enb[sb] becomes larger than in the case of a signal with noise. Due to this operation, the higher the pure tone level of the signal is, the lower a dynamic masking threshold value for the sub-band becomes. In the case of a signal with a high noise level, the dynamic masking threshold value for the sub-band becomes larger than that of a signal with a high pure tone level. Due to this operation, a masking threshold value can be dynamically corrected according to the pure tone level/noise level of an input audio signal. If the pure tone level is high, an allowable quantization error in the encoding process decreases. Accordingly, quantizing noise can be reduced.

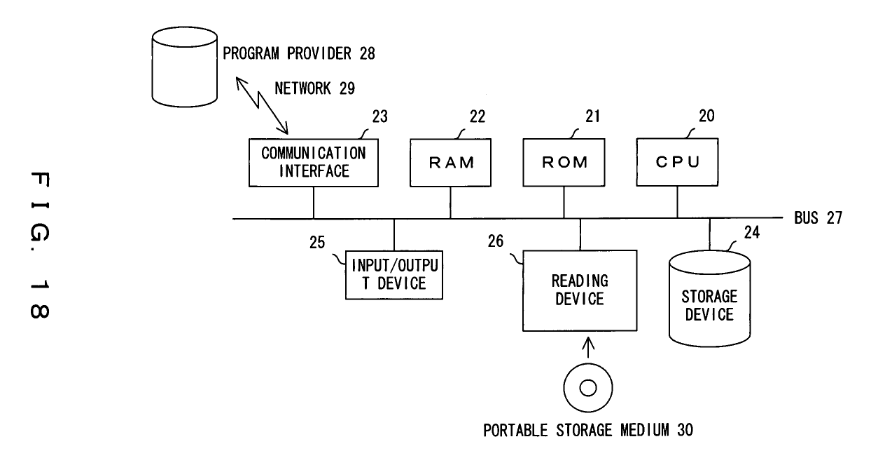

So far the audio signal encoding device and encoding program has been described in detail. However, this encoding device can be configured based on a general-purpose computer. FIG. 18 is a block diagram showing the configuration of such a computer system, that is, a hardware environment.

In FIG. 18, the computer system comprises a central processing unit (CPU) 20, a read-only memory (ROM) 21, a random-access memory (RAM) 22, a communication interface 23, a storage device 24, an input/output device 25, a portable storage medium reading device 26 and a bus 27 for connecting all the devices with each other.

For the storage device 24, a variety of types of storage devices, such as a magnetic disk and the like, can be used. In such a storage device 24 or ROM 21, programs shown in the flowcharts of FIGS. 9, 11, 13 15, 17, etc., are stored. When the CPU 20 executes such a program, tone quality can be improved by performing pure tone level determination for each sub-band in this preferred embodiment and adaptively adjusting a dynamic masking threshold value, based on the result of the determination.

Such a program can be stored in, for example, the storage device 24 by a program provider 28 via a network 29 and the interface 23. Alternatively, the program is sold in the market, can also be stored in a portable storage medium 30 sold in the market and can also be set in the reading device 26. Then, the CPU 20 executes the program. For the portable storage medium 30, a variety of types of storage media, such as a CD-ROM, a flexible disk, an optical disk, a magneto-optical disk, a DVD and the like can be use. When the reading device 26 reads the program stored in such a storage medium, this preferred embodiment can determine pure tone level for each sub-band.

As described above, according to the present invention, the pure tone level/noise level of an input audio signal can be determined based on only an MDCT coefficient, and a masking threshold value characteristic, which is the output of an auditory psychology model analysis, can be corrected according to the pure tone level/noise level signal. Thus, the size of quantizing noise in an audio signal encoding process can be reduced, which can contribute to the improvement of the tone quality of audio signal encoding/decoding equipment.

What is claimed is:

1. An encoding device which encodes audio signals, comprising:
a spectrum power calculation unit for calculating the power of each spectrum obtained by analyzing the frequency of an input audio signal;
a tonality parameter calculation unit for calculating a tonality parameter indicating the pure tone level of the input audio signal in each sub-band, using the result of the calculation when dividing the frequency range of the spectrum of the input audio signal into a plurality of sub-bands; and
a dynamic masking threshold calculation unit for calculating a dynamic masking threshold value of the masking energy of the input audio signal, using the calculated tonality parameter.

2. The audio signal encoding device according to claim 1, wherein
said tonality parameter calculation unit calculates the sum S_{S} of spectrum power each of the sub-bands, and the product S_{M} of the maximum value of spectrum power that exists in the sub-band and the width of the sub-band, and calculates the value of a tonality parameter corresponding to the value of S_{S}/S_{M}.

3. The audio signal encoding device according to claim 2, wherein
said tonality parameter calculation unit increases the value of the tonality parameter if the value of S_{S}/S_{M} is small, and decreases the value of the tonality parameter if the value of S_{S}/S_{M} is large.

4. The audio signal encoding device according to claim 3, wherein
said tonality parameter calculation unit divides the range of the value of S_{S}/S_{M} into a plurality of sub-ranges, and determines a specific value of the tonality parameter for each of the divided sub-range.

5. The audio signal encoding device according to claim 1, wherein
said tonality parameter calculation unit divides the frequency range of spectrum of the input audio signal into three sub-bands of low, middle and high sub-bands, and calculates the value of tonality parameter for each divided sub-band.

6. The audio signal encoding device according to claim 1, wherein
said dynamic masking threshold value calculation unit decreases the dynamic masking threshold value if the value of the tonality parameter is large, and increases the dynamic masking threshold value if the value of the tonality parameter is small.

7. An encoding device which encodes audio signals, comprising:
spectrum power calculation means for calculating the power of each spectrum obtained by analyzing the frequency of an input audio signal;
tonality parameter calculation means for calculating a tonality parameter indicating the pure tone level of the input audio signal in each sub-band, using the result of the calculation when dividing the frequency range of the spectrum of the input audio signal into a plurality of sub-bands; and
dynamic masking threshold calculation means for calculating a dynamic masking threshold value of the masking energy of the input audio signal, using the calculated tonality parameter.

8. A computer-readable storage medium which stores a computer program for enabling a computer to encode audio signals, the program, comprising the steps of:
calculating the power of each spectrum obtained by analyzing the frequency of an input audio signal;
calculating a tonality parameter indicating the pure tone level of the input audio signal in each sub-band when dividing the frequency range of the spectrum of the input audio signal into a plurality of sub-bands; and
calculating the dynamic masking threshold value of the masking energy of the input audio signal, using the calculated tonality parameter.

9. The storage medium, according to claim 8, wherein in said step of calculating a tonality parameter, the sum S_{S} of spectrum power each of the sub-bands, and the product S_{M} of the maximum value of spectrum power that exists in the sub-band and the width of the sub-band are calculated, and the value of a tonality parameter corresponding to the value of S_{S}/S_{M} is calculated.

10. A method for encoding audio signals, comprising:
calculating the power of each spectrum obtained by analyzing the frequency of an input audio signal;
calculating a tonality parameter indicating the pure tone level of the input audio signal in each sub-band when dividing the frequency range of the spectrum of the input audio signal into a plurality of sub-bands; and
calculating the dynamic masking threshold value of the masking energy of the input audio signal, using the calculated tonality parameter.

11. A computer data signal which is embodied in a carrier wave and represents a program for enabling a computer to encode audio signals, the program, comprising the steps of:
calculating the power of each spectrum obtained by analyzing the frequency of an input audio signal;
calculating a tonality parameter indicating the pure tone level of the input audio signal in each sub-band when dividing the frequency range of the spectrum of the input audio signal into a plurality of sub-bands; and
calculating the dynamic masking threshold value of the masking energy of the input audio signal, using the calculated tonality parameter.
